(19) United States
(12) Patent Application Publication
(10) Pub. No.: US 2016/0363378 A1
(43) Pub. Date: Dec. 15, 2016

(54) HEAT EXCHANGER AND A METHOD FOR FORMING A HEAT EXCHANGER

(71) Applicant: General Electric Company, Schenectady, NY (US)

(72) Inventors: Joel Erik Hitzelberger, Louisville, KY (US); Michael John Kempiak, Osceola, IN (US)

(21) Appl. No.: 14/736,515

(22) Filed: Jun. 11, 2015

(51) Int. Cl. F28D 1/047; F28F 13/08; B23P 15/26; F28F 1/00; F28F 1/12

(52) U.S. Cl. CPC F28D 1/0477; F28F 1/006; F28F 1/12; B23P 15/26; F28F 13/08

(57) ABSTRACT

A heat exchanger includes a plurality of projections integrally formed with a conduit. The plurality of projections is configured such that the plurality of projections conforms to at least one of a first projection arrangement or a second projection arrangement. A gap between adjacent projections of the plurality of projections along an axial direction changes along a length of the conduit in the first projection arrangement, and a length of a first group of the plurality of projections is different than a length of a second group of the plurality of projections in the second projection arrangement. A related method for forming a heat exchanger is also provided.

### FIELD OF THE INVENTION

The present subject matter relates generally to heat exchangers, such as evaporators for refrigerator appliances, and methods for forming heat exchangers.

### BACKGROUND OF THE INVENTION

Refrigerator appliances generally include sealed systems for cooling chilled chambers of the refrigerator appliance. During operation of the sealed system, a compressor generates compressed refrigerant. The compressed refrigerant flows to a condenser where the refrigerant is condensed into a liquid and is sent to an expansion device. The expansion device reduces a pressure of the refrigerant before the refrigerant enters into an evaporator as a combination of liquid and vapor. The refrigerant exits the evaporator as vapor and is transported to the compressor via a suction line. Refrigerant within the evaporator absorbs heat from the chilled chambers.

Various heat exchangers are available for use in refrigerator appliances. Certain refrigerator appliances include a spine fin heat exchangers. Spine fin heat exchangers include spine fin coils wrapped about a conduit. The spine fin coils can facilitate heat transfer between refrigerant within the conduit and ambient atmosphere about the conduit.

An efficiency of the spine fin heat exchangers can be improved by increasing a number of spine fins coils per unit length of conduit. However, increasing the number of spine fins coils can also result in an air side pressure drop. Thus, more energy may be required to operate a heat exchanger fan and achieve sufficient air flow across the spine fins. In addition, frost growth on closely positioned spine fins coils can block air flow between the spine fins over time. Further, reliably mounting the spine fins coils on the conduit can be difficult. In particular, maintaining contact between the spine fins coils and the conduit in order to facilitate conductive heat transfer between the two component can be difficult.

Accordingly, a heat exchanger with features facilitating conductive heat transfer between a primary channel for refrigerant within the heat exchanger and a secondary heat exchange surface would be useful. In addition, a heat exchanger with features facilitating air side heat exchange of the heat exchanger would be useful.

### BRIEF DESCRIPTION OF THE INVENTION

The present subject matter provides a heat exchanger. The heat exchanger includes a plurality of projections integrally formed with a conduit. The plurality of projections is configured such that the plurality of projections conforms to at least one of a first projection arrangement or a second projection arrangement. A gap between adjacent projections of the plurality of projections along an axial direction changes along a length of the conduit in the first projection arrangement, and a length of a first group of the plurality of projections is different than a length of a second group of the plurality of projections in the second projection arrangement. A related method for forming a heat exchanger is also provided. Additional aspects and advantages of the invention will be set forth in part in the following description, or may be apparent from the description, or may be learned through practice of the invention.

In a first exemplary embodiment, a heat exchanger defining an axial direction and a radial direction is provided. The heat exchanger includes a conduit having an outer surface. The conduit also has a length along the axial direction. A plurality of projections is integrally formed with the conduit. Each projection of the plurality of projections extends from the outer surface of the conduit by a length along the radial direction. The plurality of projections is configured such that the plurality of projections conforms to at least one of a first projection arrangement or a second projection arrangement. A gap between adjacent projections of the plurality of projections along the axial direction changes along the length of the conduit in the first projection arrangement. The length of a first group of the plurality of projections is different than the length of a second group of the plurality of projections in the second projection arrangement.

In a second exemplary embodiment, a method for forming a unitary heat exchanger is provided. The method includes establishing three-dimensional information of the unitary heat exchanger and converting the three-dimensional information of the unitary heat exchanger from the step of establishing into a plurality of slices. Each slice of the plurality of slices defines a respective cross-sectional layer of the unitary heat exchanger. The method also includes successively forming each cross-sectional layer of the unitary heat exchanger with an additive process. After the step of successively forming, the unitary heat exchanger includes: (1) a conduit having an outer surface and defining a length; and (2) a plurality of projections integrally formed with the conduit. Each projection of the plurality of projections extends from the outer surface of the conduit by a length. The plurality of projections is configured such that the plurality of projections conforms to at least one of a first projection arrangement or a second projection arrangement after the step of successively forming. A gap between adjacent projections of the plurality of projections changes along the length of the conduit in the first projection arrangement. The length of a first group of the plurality of projections is different than the length of a second group of the plurality of projections in the second projection arrangement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a refrigerator appliance according to an exemplary embodiment of the present subject matter.

FIG. 2 is schematic view of certain components of the exemplary refrigerator appliance of FIG. 1.

FIG. 3 provides a partial, section view of a heat exchanger according to an exemplary embodiment of the present subject matter.

FIG. 4 provides a schematic view of the exemplary heat exchanger of FIG.

3.

FIG. 5 illustrates a method for forming a unitary heat exchanger according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

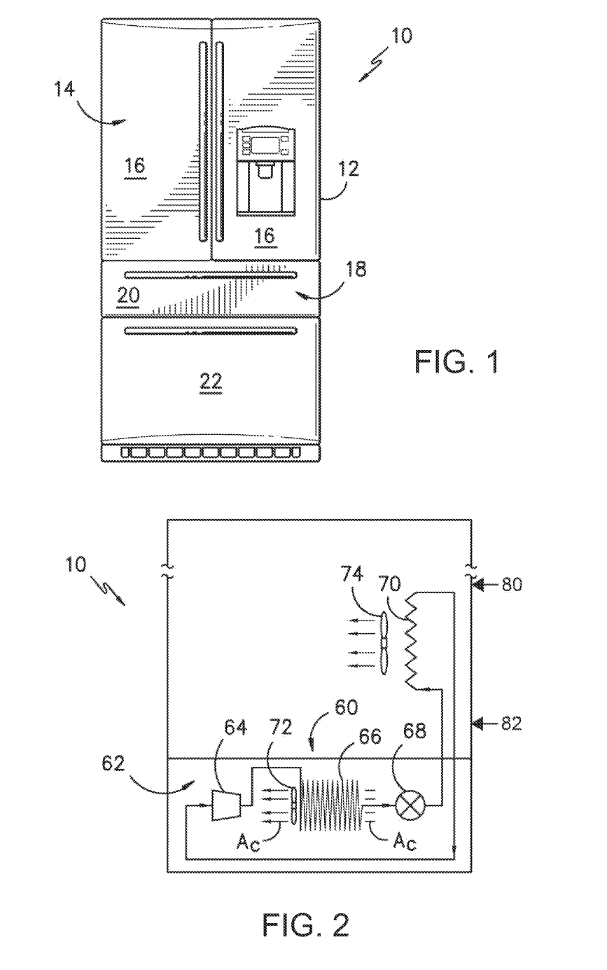

FIG. 1 depicts a refrigerator appliance 10 that incorporates a sealed refrigeration system 60 (FIG. 2). It should be appreciated that the term “refrigerator appliance” is used in a generic sense herein to encompass any manner of refrigeration appliance, such as a freezer, refrigerator/freezer combination, and any style or model of conventional refrigerator. In addition, it should be understood that the present subject matter is not limited to use in appliances. Thus, the present subject matter may be used for any other suitable purpose, such as in HVAC units.

In the exemplary embodiment shown in FIG. 1, the refrigerator appliance 10 is depicted as an upright refrigerator having a cabinet or casing 12 that defines a number of internal chilled storage compartments. In particular, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18 on suitable slide mechanisms.

FIG. 2 is a schematic view of certain components of refrigerator appliance 10, including a sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series and charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

Within refrigeration system 60, refrigerant flows into compressor 64, which operates to increase the pressure of the refrigerant. This compression of the refrigerant raises its temperature, which is lowered by passing the refrigerant through condenser 66. Within condenser 66, heat exchange with ambient air takes place so as to cool the refrigerant. A condenser fan 72 is used to pull air across condenser 66, as illustrated by arrows A_{C}, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device (e.g., a valve, capillary tube, or other restriction device) 68 receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70. An evaporator fan 74 is used to pull air across evaporator 70 and circulate air within compartments 14 and 18 of refrigerator appliance 10.

Collectively, the vapor compression cycle components in a refrigeration circuit, associated fans, and associated compartments are sometimes referred to as a sealed refrigeration system operable to force cold air through compartments 14, 18 (FIG. 1). The refrigeration system 60 depicted in FIG. 2 is provided by way of example only. Thus, it is within the scope of the present subject matter for other configurations of the refrigeration system to be used as well.

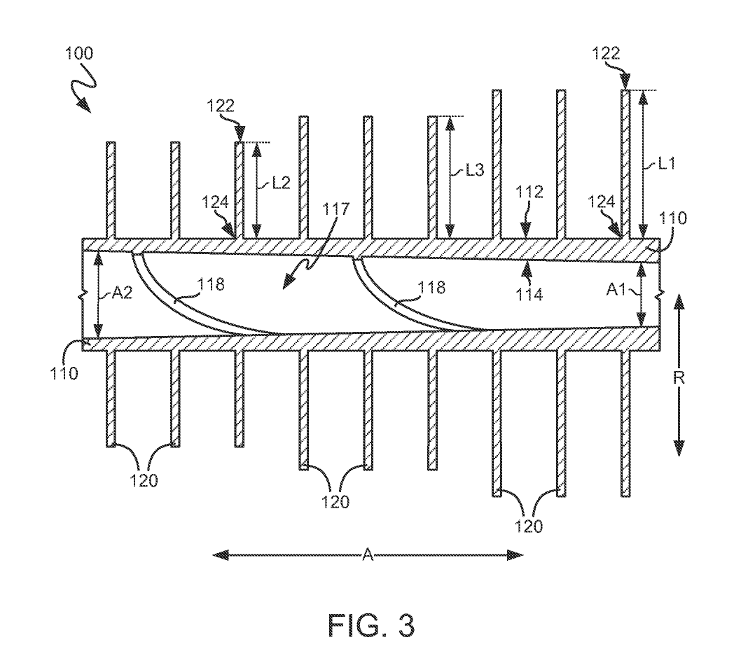

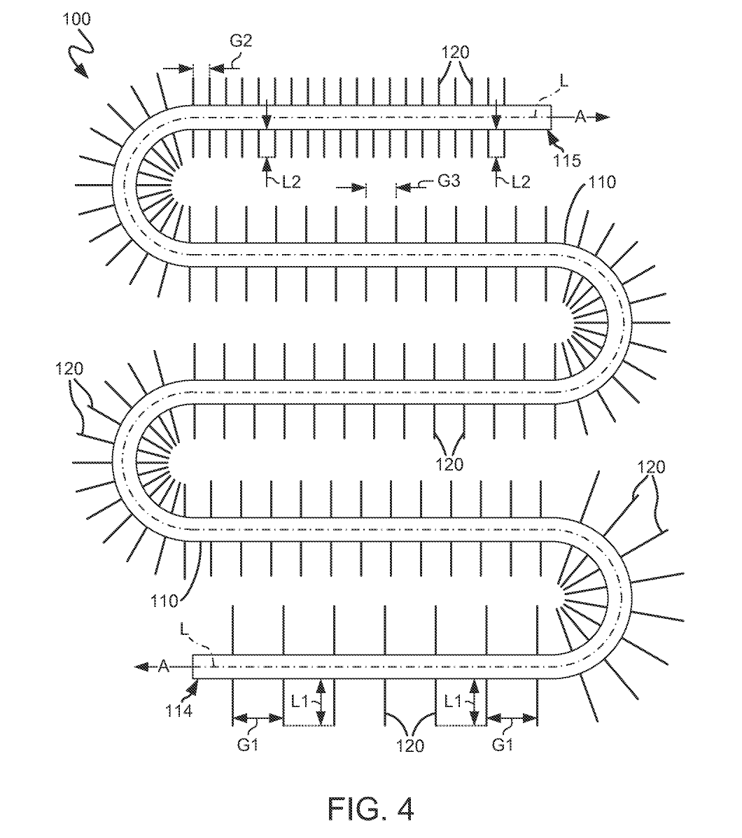

FIG. 3 provides a partial, section view of a heat exchanger 100 according to an exemplary embodiment of the present subject matter. FIG. 4 provides a schematic view of heat exchanger 100. Heat exchanger 100 may be used in any suitable refrigeration system or HVAC system. As an example, heat exchanger 100 may be used in refrigeration system 60 of refrigerator appliance 10 (FIG. 2), e.g., as condenser 66 or evaporator 70. Heat exchanger 100 includes features for improving performance of an associated refrigeration system or HVAC system, as discussed in greater detail below. Heat exchanger 100 also defines an axial direction A and a radial direction R.

As may be seen in FIGS. 3 and 4, heat exchanger 100 includes a conduit 110 and a plurality of projections 120. Conduit 110 and projections 120 are integrally formed with each other. Thus, e.g., conduit 110 and projections 120 may be formed of or with a continuous piece of thermally conductive material. As an example, conduit 110 and projections 120 may be formed of or with a continuous metal, such as copper, aluminum, alloys thereof, etc. As discussed in greater detail below, heat exchanger 100 may be formed with a suitable additive process in order to integrally form conduit 110 and projections 120 with each other.

Conduit 110 is configured for containing a refrigerant therein and directing a flow of refrigerant therethrough. In particular, conduit 110 has an outer surface 112 and an inner surface 116. Outer surface 112 and inner surface 116 of conduit 110 are positioned opposite each other, e.g., such that outer surface 112 and inner surface 116 of conduit 110 are spaced apart from each other along the radial direction R. Conduit 110, e.g., inner surface 116 of conduit 110, defines an interior volume 117. Refrigerant may flow through interior volume 117 within conduit 110. Conduit 110 may define multiple passages for refrigerant flow within conduit 110 in alternative exemplary embodiments.

Projections 120 are disposed or formed on or at outer surface 112 of conduit 110, and projections 120 extend away from outer surface 112 of conduit 110, e.g., along the radial direction R. Thus, projections 120 may extend into ambient air about heat exchanger 100. Projections 120 assist with conducting thermal energy between refrigerant within conduit 110 and ambient air about heat exchanger 100. Thus, e.g., when used as a condenser, projections 120 reject heat from refrigerant within conduit 110 to ambient air about heat exchanger 100. Conversely, e.g., when used as an evaporator, projections 120 heat refrigerant within conduit 110 with thermal energy from ambient air about heat exchanger 100.

By integrally forming projections 120 with conduit 110, heat transfer between projections 120 and conduit 110 may be improved relative to having separate projections mounted or wrapped on a conduit. In particular, no thermal break or gap may be positioned between projections 120 and conduit 110 when projections 120 with conduit 110 are integrally formed with each other, as shown in FIG. 3. Thus, heat transfer between projections 120 and conduit 110 may be facilitated by integrally forming projections 120 with conduit 110.

Projections 120 may have any suitable shape or form on conduit 110. For example, projections 120 may be spine fins, wires, plates, etc. In addition, various combinations of projections 120 may be formed on conduit 110. Thus, e.g., projections 120 may include any suitable combination of spine fins, wires, plates, etc. As discussed in greater detail below, the sizing, shape, orientation and/or spacing of projections 120 may also vary or change along conduit 110. Thus, the sizing, shape, orientation and/or spacing projections 120 may be adjusted (e.g., optimized) for heat transfer between projections 120 and conduit 110.

As may be seen in FIG. 4, conduit 110 defines a length L, e.g., along the axial direction A. Projections 120 are distributed (e.g., spaced apart from each other) along the length L of conduit 110. In addition, a gap or space between adjacent projections of projections 120, e.g., along the axial direction A, may change along the length L of conduit 110. The gap between adjacent projections of projections 120 may be any suitable gap. For example, the gap between adjacent projections of projections 120, e.g., along the axial direction A, may vary between a twelfth of an inch and a quarter of an inch along the length L of conduit 110.

Conduit 110 may also extend between a first end portion 114 and a second end portion 115, e.g., along the axial direction A. As shown in FIG. 4, conduit 110 may be formed into a serpentine shape and/or curved shape between the first and second end portions 114, 115 of conduit 110 such that the axial direction A is curved and not completely rectilinear in certain exemplary embodiments. Projections 120 at or adjacent first end portion 114 of conduit 110 may be spaced apart or separated by gaps having a first gap size G1, and projections 120 at or adjacent second end portion 115 of conduit 110 may be spaced apart or separated by gaps having a second gap size G2. The first gap size G1 may be greater than the second gap size G2. Thus, projections 120 at or adjacent second end portion 115 of conduit 110 may be closer together than projections 120 at or adjacent first end portion 114 of conduit 110. In addition, as may be seen in FIG. 4, projections 120 positioned between first and second end portions 114, 115 of conduit 110 may be spaced apart or separated by gaps or spaces different than the first and second gap sizes G1, G2, such as a third gap size G3.

The gap size between adjacent projections of projections 120 on conduit 110 may vary in any suitable manner along the length L of conduit 110. For example, adjacent projections of projections 120 on each rectilinear portion of conduit 110 may be uniformly spaced, and the gap size between adjacent projections of projections 120 may change between rectilinear portions of conduit 110, as shown in FIG. 4. In alternative exemplary embodiments, the gap size between adjacent projections of projections 120 on rectilinear portions of conduit 110 may also vary.

Varying the gap size between adjacent projections of projections 120 on conduit 110 may assist with improving performance of heat exchanger 100. For example, an airflow distribution pattern across heat exchanger 100 may more uniform relative to heat exchangers with constant gap sizes. In addition, the frost holding capacity of heat exchanger 100 may be increased relative to heat exchangers with constant gap sizes by providing low projection density at high frost areas and high projection density away from the high frost areas.

As an example, projections 120 at the first gap size G1 may be positioned at or adjacent a bottom portion 82 (FIG. 2) of a chilled chamber of refrigerator appliance 10, and projections 120 at the second gap size G2 may be positioned at or adjacent a top portion 80 (FIG. 2) of the chilled chamber of refrigerator appliance 10. Thus, heat exchanger 100 may have a higher projection density at or adjacent top portion 80 of the chilled chamber relative to the bottom portion 82 of the chilled chamber. In such a manner, frost build up at an inlet of projection 100 may be limited or reduced. In particular, by varying the gap size between adjacent projections of projections 120 on conduit 110 such that the air inlet location has larger spaces between adjacent projections of projections 120 and decreasing the gap size between adjacent projections of projections 120 on conduit 110 along the airflow path on heat exchanger 100, heat exchanger 100 may be more tolerant to frost buildup.

Turning back to FIG. 3, projections 120 also extend from outer surface 112 of conduit 110, as discussed above. In particular, each projection of projections 120 may extend from outer surface 112 of conduit 110 by a respective extension or length along the radial direction R such that a distal end portion 122 of each projection of projections 120 is disposed away from a proximal end portion 124 of each projection of projections 120 by the respective length along the radial direction R. The proximal end portion 124 of each projection of projections 120 may be positioned at outer surface 112 of conduit 110.

The length of projections 120, e.g., along the radial direction R, may also vary or change along the length L of conduit 110. As shown in FIG. 4, a first group of projections 120, e.g., at or adjacent first end portion 114 of conduit 110, may extend from outer surface 112 of conduit 110 by a first length L1 along the radial direction R, and a second group of projections 120, e.g., at or adjacent second end portion 115 of conduit 110, may extend from outer surface 112 of conduit 110 by a second length L2 along the radial direction R. The first length L1 is different than the first length L2. As an example, the first length L1 may be greater than the first length L2. Thus, projections 120 at or adjacent second end portion 115 of conduit 110 may be shorter than projections 120 at or adjacent first end portion 114 of conduit 110, as shown in FIG. 4. In alternative exemplary embodiments, the first length L1 may be less than the first length L2. In addition, as may be seen in FIG. 4, projections 120 positioned between first and second end portions 114, 115 of conduit 110 may extend from outer surface 112 of conduit 110 by a length or lengths different than the first and second lengths L1, L2, such as a third length L3.

Varying the length that projections 120 extend from outer surface 112 of conduit 110 may assist with improving performance of heat exchanger 100. For example, an airflow distribution pattern across heat exchanger 100 may more uniform relative to heat exchangers with constant length spines or plates. In addition, the frost holding capacity of heat exchanger 100 may be increased relative to heat exchangers with constant spline or plate sizes by providing low projection density at high frost areas and high projection density away from the high frost areas.

As shown in FIG. 3, the sizing, shapes and/or features of conduit 110 may also vary or change, e.g., along the length L of conduit 110. In particular, conduit 110 may also have any suitable cross-sectional shape along the length L of conduit 110. For example, conduit 110 may have a circular or oval cross-section, e.g., in a plane that is perpendicular to the axial direction A. As another example, the cross-sectional area of interior volume 117 of conduit 110, e.g., in a plane that is perpendicular to the axial direction A, may change along the length L of conduit 110. In particular, interior volume 117 of conduit 110 may have a first cross-sectional area A1, e.g., in a plane that is perpendicular to the axial direction A, at or adjacent first end portion 114 of conduit 110, and interior volume 117 of conduit 110 may have a second cross-sectional area A2, e.g., in a plane that is perpendicular to the axial direction A, at or adjacent second end portion 115 of conduit 110. The second cross-sectional area A2 is different than the first cross-sectional area A1. For example, the second cross-sectional area A2 may be larger than the first cross-sectional area A1. Thus, interior volume 117 of conduit 110 may taper (e.g., contract or expand) between first and second end portions 114, 115 of conduit 110. Further, conduit 110 may define a, e.g., helical or rifled, ridge 118 at inner surface 116 of conduit 110. Ridge 118 may extend into interior volume 117 of conduit 110, e.g., along the radial direction R and direct flow through interior volume 117 of conduit 110.

Such features of conduit 110 may assist with improving performance of heat exchanger 100. For example, tapering the cross-sectional area of interior volume 117 of conduit 110 may allow heat exchanger 100 to be tuned to account for refrigerant pressure reduction within interior volume 117 of conduit 110 as the refrigerant flows through heat exchanger.

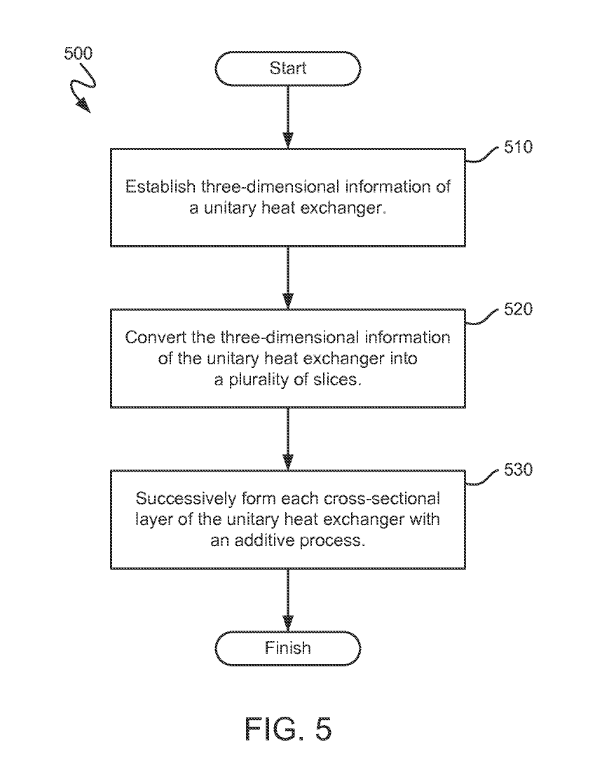

FIG. 5 illustrates a method for forming a unitary heat exchanger according to an exemplary embodiment of the present subject matter. Method 500 may be used to form any suitable heat exchanger. For example, method 500 may be used to form heat exchanger 100 (FIGS. 3 and 4). Method 500 permits formation of various features of heat exchanger 100, as discussed in greater detail below.

Method 500 includes fabricating heat exchanger 100 as a unitary heat exchanger, e.g., such that heat exchanger 100 is formed of a continuous piece of metal or other suitable material or combination of materials that are integrally formed together. More particularly, method 500 includes manufacturing or forming heat exchanger 100 using an additive process, such as Fused Deposition Modeling (FDM), Selective Laser Sintering (SLS), Direct Metal Laser Sintering (DMLS), Laser Net Shape Manufacturing (LNSM), electron beam sintering and other known processes. An additive process fabricates components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 510, three-dimensional information of heat exchanger 100 is determined. As an example, a model or prototype of heat exchanger 100 may be scanned to determine the three-dimensional information of heat exchanger 100 at step 510. As another example, a model of heat exchanger 100 may be constructed using a suitable CAD program to determine the three-dimensional information of control panel 200 at step 510. At step 520, the three-dimensional information is converted into a plurality of slices that each defines a cross-sectional layer of heat exchanger 100. As an example, the three-dimensional information from step 510 may be divided into equal sections or segments, e.g., along a central axis of heat exchanger 100 or any other suitable axis. Thus, the three-dimensional information from step 510 may be discretized at step 520, e.g., in order to provide planar cross-sectional layers of heat exchanger 100.

After step 520, heat exchanger 100 is fabricated using the additive process, or more specifically each layer is successively formed at step 530, e.g., by fusing or binding a metal or other suitable conductive material using laser energy or heat. The layers may have any suitable size. For example, each layer may have a size between about five ten-thousandths of an inch and about one thousandths of an inch. Heat exchanger 100 may be fabricated using any suitable additive manufacturing machine as step 530. For example, any suitable laser sintering machine may be used at step 530.

Utilizing method 500, heat exchanger 100 may have fewer components and/or joints than known heat exchangers. Specifically, heat exchanger 100 may require fewer components because heat exchanger 100 may be a single piece of continuous metal, e.g., rather than multiple pieces of material joined or connected together with welds, fasteners, etc. In addition, method 500 may form heat exchanger 100 such that projections 120 have various lengths and shapes. Further, method 500 may form heat exchanger 100 such that projections 120 have various spacing between adjacent projections of projections 120. Such arrangement of projections 120 may assist with providing an efficient heat exchanger.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A heat exchanger defining an axial direction and a radial direction, the heat exchanger comprising:
a conduit having an outer surface, the conduit having a length along the axial direction;
a plurality of projections integrally formed with the conduit, each projection of the plurality of projections extending from the outer surface of the conduit by a length along the radial direction, the plurality of projections configured such that the plurality of projections conforms to at least one of a first projection arrangement or a second projection arrangement, a gap between adjacent projections of the plurality of projections along the axial direction changing along the length of the conduit in the first projection arrangement, the length of a first group of the plurality of projections being different than the length of a second group of the plurality of projections in the second projection arrangement.

2. The heat exchanger of claim 1, wherein the plurality of projections is configured such that the plurality of projections conforms to both the first projection arrangement and the second projection arrangement.

3. The heat exchanger of claim 1, wherein the gap between adjacent projections of the plurality of projections along the axial direction varies between a twelfth of an inch and a quarter of an inch along the length of the conduit.

4. The heat exchanger of claim 1, wherein the conduit is formed into a serpentine pattern along the length of the conduit.

5. The heat exchanger of claim 1, wherein the conduit defines an interior volume, a cross-sectional area of the interior volume of the conduit changing along the length of the conduit.

6. The heat exchanger of claim 1, wherein the projections of the plurality of projections comprise spine fins, wires or plates.

7. The heat exchanger of claim 1, wherein the conduit and the plurality of projections are formed of a continuous piece of metal.

8. The heat exchanger of claim 7, wherein the metal comprises aluminum or copper.

9. The heat exchanger of claim 1, wherein the conduit has an inner surface positioned opposite the outer surface of the conduit, the conduit also defining at least one helical ridge at the inner surface of the conduit.

10. A method for forming a unitary heat exchanger, comprising:
establishing three-dimensional information of the unitary heat exchanger;
converting the three-dimensional information of the unitary heat exchanger from said step of establishing into a plurality of slices, each slice of the plurality of slices defining a respective cross-sectional layer of the unitary heat exchanger; and
successively forming each cross-sectional layer of the unitary heat exchanger with an additive process;
wherein, after said step of successively forming, the unitary heat exchanger comprises: (1) a conduit having an outer surface and defining a length; and (2) a plurality of projections integrally formed with the conduit, each projection of the plurality of projections extending from the outer surface of the conduit by a length, the plurality of projections configured such that the plurality of projections conforms to at least one of a first projection arrangement or a second projection arrangement after said step of successively forming, a gap between adjacent projections of the plurality of projections changing along the length of the conduit in the first projection arrangement, the length of a first group of the plurality of projections being different than the length of a second group of the plurality of projections in the second projection arrangement.

11. The method of claim 10, wherein the additive process comprises at least one of fused deposition modeling, selective laser sintering and direct metal laser sintering.

12. The method of claim 10, wherein the unitary heat exchanger is a single, continuous piece of material after said step of successively forming.

13. The method of claim 12, wherein the single, continuous piece of material is a metal.

14. The method of claim 13, wherein the metal comprises aluminum or copper.

15. The method of claim 10, wherein the plurality of projections is configured such that the plurality of projections conforms to both the first projection arrangement and the second projection arrangement after said step of successively forming.

16. The method of claim 10, wherein the conduit defines a plurality of passages within the conduit after said step of successively forming.

17. The method of claim 10, wherein the gap between adjacent projections of the plurality of projections along the axial direction varies between a twelfth of an inch and a quarter of an inch along the length of the conduit after said step of successively forming.

18. The method of claim 10, wherein the conduit has a serpentine shape along the length of the conduit after said step of successively forming.

19. The method of claim 10, wherein the conduit defines an interior volume and a cross-sectional area of the interior volume of the conduit changes along the length of the conduit after said step of successively forming.

20. The method of claim 10, wherein the projections of the plurality of projections comprise spine fins, wires or plates.
